(19) United States
(12) Patent Application Publication
(10) Pub. No.: US 2025/0374206 A1
(43) Pub. Date: Dec. 4, 2025

(54) METHOD AND APPARATUS FOR POWER HEADROOM

(71) Applicant: Nokia Technologies Oy, Espoo (FI)

(72) Inventors: Chunli WU, Beijing (CN); Samuli Heikki TURTINEN, Oulu (FI); Tero HENTTONEN, Espoo (FI)

(21) Appl. No.: 18/873,570

(22) PCT Filed: Jun. 22, 2022
(86) PCT No.: PCT/CN2022/100587

§ 371 Date: Dec. 10, 2024

(51) Int. Cl. H04W 52/36; H04W 72/21

(52) U.S. Cl. CPC H04W 52/365; H04W 72/21

(57) ABSTRACT

Embodiments of the present disclosure relate to power headroom in dual connectivity. A terminal device obtains a power headroom, PH, corresponding to a serving cell in a first cell group, CG, based on combined transmission power of multiple physical uplink shared channel, PUSCH, transmissions in the serving cell. Then, the terminal device transmits a PH report, PHR, comprising information of the obtained PH to a second CG. In this way, the actual power status for serving cells configured with multiple transmissions in a cell group and reception points, TRPs, can be reported to another cell group configured without two-PHR mode.

### FIELD

Embodiments of the present disclosure generally relate to the field of communication, and in particular, to a method, devices, apparatus and computer readable storage medium for power headroom (PH).

### BACKGROUND

With development of communication technology, terminal devices may be connected to a serving cell via multiple transmit-receive points (TRPs) in the serving cell, to improve the communication robustness and configuration flexibility of the serving cell. And terminal devices may also be served by two cell groups (CG) simultaneously, which may also be called dual connectivity (DC), to improve communication capacity and coverage.

In dual connectivity scenarios, a PH report (PHR) may be triggered for both Medium Access Control (MAC) entities corresponding two CGs. A two-PHR Mode has been introduced to support report of two PH for a serving cell configured with the multiple TRP physical uplink shared channel (PUSCH) transmissions.

In a conventional PHR procedure, if a MAC entity or a CG is configured with the two-PHR mode, the enhanced PHR MAC CE for multiple TRP PUSCH transmissions shall be used for this MAC entity, and for all serving cells configured with multiple TRP PUSCH transmissions, the terminal device shall report two PH value in the enhanced MAC CE. But for different configurations in a dual connectivity scenario, some more detail information should be considered.

### SUMMARY

In general, example embodiments of the present disclosure provide a method, apparatus and computer readable storage medium for power headroom reporting in dual connectivity.

In a first aspect, there is provided a terminal device. The terminal device may comprise one or more transceivers; and one or more processors communicatively coupled to the one or more transceivers, and the one or more processors are configured to cause the terminal device to obtain a power headroom, PH, corresponding to a serving cell in a first cell group, CG, based on combined transmission power of multiple physical uplink shared channel, PUSCH, transmissions in the serving cell; and transmit a PH report, PHR, comprising information of the obtained PH to a second CG.

In a second aspect, there is provided a network device. The network device may comprise one or more transceivers; one or more processors communicatively coupled to the one or more transceivers, and the one or more processors are configured to cause the network device to receive a power headroom report, PHR, comprising information of a power headroom, PH from a terminal device, and extract the PH corresponding to a serving cell from the PHR, wherein the PH corresponding to the serving cell in a first cell group, CG, and indicates a power headroom obtained based on combined transmission power of multiple physical uplink shared channel, PUSCH, transmissions in the serving cell.

In a third aspect, there is provided a method implemented at a terminal device. The method may comprise obtaining a power headroom, PH, corresponding to a serving cell in a first cell group, CG, based on combined transmission power of multiple physical uplink shared channel, PUSCH, transmissions in the serving cell; and transmitting a PH report, PHR, comprising information of the obtained PH to a second CG.

In a fourth aspect, there is provided a method implemented at a network device. The method may comprise receiving a power headroom report, PHR, comprising information of a power headroom, PH, from a terminal device, and extracting the PH corresponding to a serving cell from the PHR, wherein the PH corresponding to the serving cell in a first cell group, CG, and indicates a PH obtained based on combined transmission power of multiple physical uplink shared channel, PUSCH, transmissions in the serving cell.

In a fifth aspect, there is provided an apparatus of terminal device. The apparatus may comprise means for obtaining a power headroom, PH, corresponding to a serving cell in a first cell group, CG, based on combined transmission power of multiple physical uplink shared channel, PUSCH, transmissions in the serving cell; and means for transmitting a PH report, PHR, comprising information of the obtained PH to a second CG.

In a sixth aspect, there is provided an apparatus of network device. The apparatus may comprise means for receiving a power headroom report, PHR, comprising information of a power headroom, PH, from a terminal device, and means for extracting the PH corresponding to a serving cell from the PHR, wherein the PH corresponding to the serving cell in a first cell group, CG, and indicates a PH obtained based on combined transmission power of multiple physical uplink shared channel, PUSCH, transmissions in the serving cell.

In a seventh aspect, there is provided a terminal device. The terminal device may comprise at least one processor; and at least one memory including computer program codes, wherein the at least one memory and the computer program codes are configured to, with the at least one processor, cause the terminal device to obtain a power headroom, PH, corresponding to a serving cell in a first cell group, CG, based on combined transmission power of multiple physical uplink shared channel, PUSCH, transmissions in the serving cell; and transmit a PH report, PHR, comprising information of the obtained PH to a second CG.

In an eighth aspect, there is provided a network device. The network device may comprise at least one processor; and at least one memory including computer program codes, wherein the at least one memory and the computer program codes are configured to, with the at least one processor, cause the network device to receive a power headroom report, PHR, comprising information of a power headroom, PH, from a terminal device, and extract the PH corresponding to a serving cell from the PHR, wherein the PH corresponding to the serving cell in a first cell group, CG, and indicates a PH obtained based on combined transmission power of multiple physical uplink shared channel, PUSCH, transmissions in the serving cell.

In a ninth aspect, there is provided a non-transitory computer readable medium comprising program instructions for causing an apparatus to perform at least the method according to third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a flowchart of a method implemented at a terminal device according to some embodiments of the present disclosure;

FIG. 3 illustrates an example PHR MAC CE format which can be used in example embodiments of the present disclosure;

FIG. 4 illustrates a flowchart of a method implemented at a network device according to some other embodiments of the present disclosure;

FIG. 5 illustrates a simplified block diagram of an apparatus that is suitable for implementing embodiments of the present disclosure; and

FIG. 6 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, a PHR could be triggered to provide power headroom for each activated serving cell with uplink, which could be the difference between the maximum allowable transmission power for a serving cell and the uplink transmission power currently evaluated, wherein the maximum allowable transmission power configured by a serving cell communicated with the terminal device with potential necessary power back-off for different purposes (e.g. maximum power reduction, MPR, depending on used MCS, or power management-maximum power reduction, P-MPR, depending on body proximity detection, or additional maximum power reduction, A-MPR, depending on regulatory emission requirements) deducted. Thus, the gNB can control power and schedule resource for the terminal device based on the PHR.

As mentioned above, the term “TRP” refers to a transmit-receive point having an antenna array (with one or more antenna elements) at the network side located at a specific geographical location, which may be used for transmitting and/or receiving signals to/from the terminal device. In embodiment of the present disclosure, a TRP may refer to network equipment with physical functionalities, including but not limited to Macro Cell, micro cell, an RRH, an Integrated Access and Backhaul (IAB) node, a relay, a femto node, a pico node, etc. Physical functionalities may include for example coding/decoding, precoding, modulation/demodulation etc. Although some embodiments of the present disclosure are described with reference to two TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

In dual connectivity (DC) scenarios, such as dual connectivity in Long Term Evolution (LTE DC), Evolved Universal Terrestrial Radio Access (E-UTRA)-New Radio (NR) Dual Connectivity (EN-DC), NR-E-UTRA Dual Connectivity (NE-DC), NR Dual Connectivity (NR-DC) a PHR may be triggered for both Medium Access Control (MAC) entities.

In addition, in NR Rel-17, enhanced multiple entry PHR MAC control element (CE) for multiple transmit receive points (TRP) MAC CE has been introduced by the 3GPP work item for Further enhanced MIMO (FeMIMO) with the intent to support multiple TRPs for uplink and downlink, in order to report more information for each serving cell, e.g., PH values for multiple TRPs.

In a conventional PHR procedure, if a MAC entity or CG is configured with the two-PHR mode, the enhanced PHR MAC CE for multiple TRP PUSCH transmissions shall be used for this MAC entity, and for each serving cell configured with multiple TRP PUSCH transmissions in the CG, the terminal device shall report two PH values in the enhanced MAC CE. If a PHR is transmitted towards a MAC entity configured without two-PHR mode, the PHR comprises only one PH for a serving cell configured with multiple TRPs. The PH reporting to a MAC entity configured without two-PHR mode may need to be enhanced.

For example, if one MAC entity is not configured with two-PHR mode for m-TRP and then only one PH from the multiple PHs for a serving cell is reported, and this does not work well either since it does not include full information about the power status. This may lead to erroneous scheduling decisions by the node that does not use/support two-PHR mode or multiple TRPs.

According to embodiments of the present disclosure, there is provided a solution for PH or for PHR. In this solution, a terminal device obtains a PH corresponding to a serving cell in a first CG, based on combined transmission power of multiple PUSCH transmissions in the serving cell. Moreover, the terminal device transmits a PHR comprising information of the obtained PH to a second CG. The second CG may be a CG associated with a MAC entity configured without two-PHR mode. As such, in embodiments of the present disclosure, the actual power status for serving cells configured with multiple TPR PUSCH transmissions can be reported to the second CG configured without two-PHR mode. Since the other gNB does not need to consider the details of how much power used for each TRP of the serving cells, thereby reducing PHR overhead for cross cell group. In addition, legacy NW nodes could be compatible when one of the cell groups is provided by a legacy NW node configured without two-PHR mode. Therefore, this solution could provide a both flexible and efficient PH reporting.

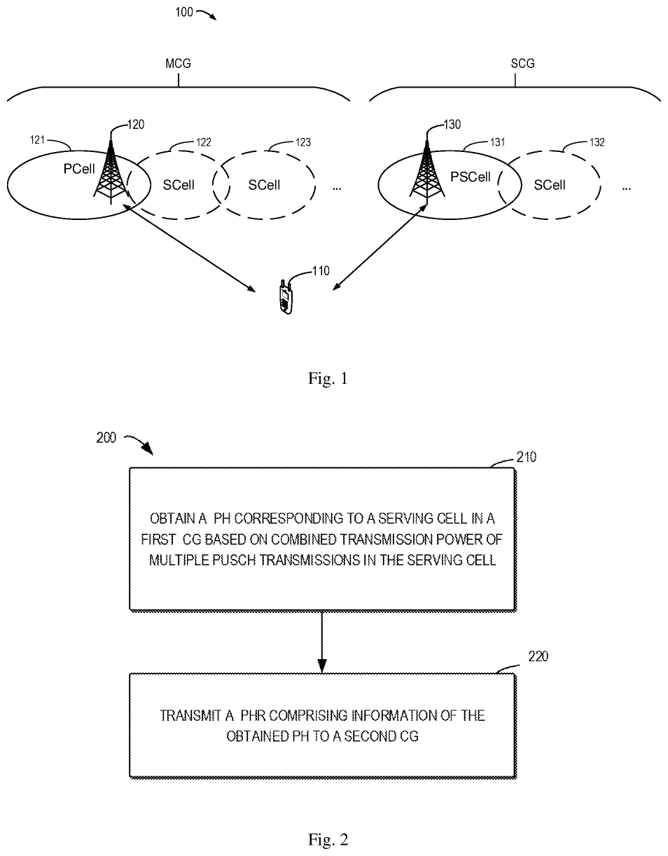

Example embodiments of the present disclosure for PH reporting will be described below with reference to FIGS. 1-6. However, it shall be noticed that the key idea of reporting the PH by combining multiple uplink transmissions can be applied in any communication system or scenario which involves similar issues and it could also be used as an alternative to the two-PHR mode. In addition, the above-mentioned multiple uplink transmissions are not limited to date transmission such as PUSCH transmission and they can be multiple physical uplink control channel (PUCCH) transmissions, sounding reference signal (SRS) real transmissions, too, or mixture of these transmissions thereof.

FIG. 1 illustrates an example network environment 100 in which example embodiments of the present disclosure may be implemented. The environment 100, which may be a part of a communication network, comprises terminal devices and network devices.

As illustrated in FIG. 1. in the network environment 100, a first device 110 is configured with for example carrier aggregation (CA) and in dual-connectivity (DC) with a second device 120 and a third device 130. The first device 110 may be implemented as the terminal device (which may be also referred to as the terminal device 110 or UE 110 hereinafter). The second device 120 and the third device 130 may be network devices (which may be referred to as gNBs 120 and 130, or network devices 120 and 130), such as, base stations for providing radio coverage to the first device 110.

In dual connectivity (DC) mode, a terminal device can be served by a master cell group (which may be also referred to as MCG or first CG or second CG hereinafter) and a secondary cell group (which may be also referred to as SCG or second CG or first CG hereinafter). The MCG may be a group of serving cells associated with the master radio access network (RAN) node, and it could be understood as the cell group, which a cell in which UE first initiates random access (RACH) belongs to. There may be a plurality of serving cells in the MCG, the serving cell in which the UE first initiating the initial access may be called Primary Cell (PCell), other serving cells may be called SCell (Secondary Cell), which are not necessary but optional. Similarly, there is a primary cell in the SCG, which called Primary Secondary Cell (PSCell), the PSCell can also be simply understood as the cell where the initial access is initiated in the SCG. In addition, the SCG may optionally comprise one or more SCells.

As shown in FIG. 1, the second device 120 provides and manages the MCG including serving cells 121,122 and 123. The third device 130 provides and manages the SCG including serving cells 130,131 and 132. It should be noted that the numbers of serving cells included in the MCG and SCG are given for illustrative purpose. Depending on network deployment, resource configuration, actual demands, etc., there may be more or less serving cells in each of MCG and SCG.

In a scenario of power split between the two cell groups, the gNB can configure maximum transmission power for each cell group. In such a case, cross cell group PH reporting to be used by the NW to reduce PH overhead, thereby improving system performance and system efficiency. The term “cross cell group” used herein may refer to providing information of one cell group to another cell group, and the term “cross cell group PH reporting” may refer to reporting PH information of the serving cell(s) of one cell group to another cell group. For example, with “cross cell group PH reporting,” the UE would report PH of the cells associated with the SCG in a PHR transmitted to MCG, or report PH of the cells associated with MCG in a PHR transmitted to SCG.

The first device 110 may communicate with the second device 120 and/or the third device 130 via multiple TRPs provided by a serving cell 122. As mentioned, if a MAC entity corresponding to SCG is configured with the two-PHR mode, the enhanced PHR MAC CE for multiple TRP PUSCH transmissions shall be used for this MAC entity, and for the serving cells 122 configured with multiple TRP PUSCH transmissions, the terminal device shall report two PH value in the enhanced MAC CE. If a PHR is transmitted towards a MAC entity configured without two-PHR mode, the PHR comprises only one PH for a serving cell configured with multiple TRPs, wherein the PH is determined by combining multiple PUSCH transmissions on for example the multiple TPRs in the serving cell, An example of the number of TRPs is two. However, it is to be understood that the terminal device 120 may also communicate with the network device via more than two TRPs, for example, three or above.

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G) and the fifth generation (5G) or 5G beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

FIG. 2 illustrates a flowchart of a method 200 implemented at a terminal device according to some embodiments of the present disclosure. For the purpose of discussion, the method 200 will be described from the perspective of the terminal device 110 with reference to FIG. 1. It is to be understood that method 200 may further include additional blocks not shown and/or omit some shown blocks, and the scope of the present disclosure is not limited in this regard.

At block 210, the terminal device 110 may obtain a PH corresponding to a serving cell in a first CG based on combined transmission power of multiple PUSCH transmissions in the serving cell. In other words, one PH corresponding to a serving cell may be generated when there is multiple PUSCH transmissions configured in the serving cell.

In some embodiments, the terminal device may be configured with dual connectivity with the first CG and the second CG. Additionally or alternatively, wherein the serving cell is configured with multiple transmission and reception points, TRPs, and the multiple PUSCH transmissions are on the multiple TPRs. For example, the terminal device 110 may be communicated with the serving cell via two TRPs.

In some embodiments, the obtaining a PH corresponding to a serving cell may comprise obtaining the PH corresponding to the serving cell in the first CG when the second CG is configured without a two-PHR mode. In other words, the terminal device 110 could obtain the PH based on the CGs configurations. The terminal device may check configuration of PHR mode, and when a CG is configured without two-PHR mode, while the PH report is to be transmitted to CG, i.e., the MAC entity corresponding to the CG, the PH may be determined by combining transmission power of multiple PUSCH transmissions in each of serving cells, if multiple transmission are being performed for a serving cell. In this case, even if the CG does not support two-PHR mode and thus does not comprehend multiple PH entries per serving cell, it could also learn the real power headroom of the serving cells of the other CG without knowing whether the serving cells of the other CG support or are configured with multiple TRPs.

In some embodiments, the first CG may be configured with the two-PHR mode. In other words, the first CG may support two-PHR and thus there might be serving cells configured with multiple TRPs and the second CG to which the PHR is reported may not support two-PHR mode.

At block 220, the terminal device 110 may transmit a PH report, PHR, comprising information of the obtained PH to a second CG. In other words, the PHR comprising information of the obtained PH will be a cross cell group PHR, and the network device may obtain the information of the PH from the PHR. In the cross-cell group PH reporting, PH information of activated serving cells of both the first CG and the second CG are reported.

In an example, the terminal device 110 may obtain a PH in the case of cross cell group report and when the CG to which the PHR is to be transmitted is configured without two-PHR mode.

In some embodiments, the obtaining a PH corresponding to a serving cell may comprise obtaining the PH corresponding to the serving cell in the first CG and the PHR is transmitted to the second CG, regardless whether the second CG is configured with the two-PHR mode. In other words, in these embodiments, as long as the PHR is a cross cell group PHR, the proposed PHR solution in the present disclosure can be utilized, without consider whether the second is configured with the two-PHR or not.

Thus, the PHR may always comprise only one PH for cross cell group reporting regardless of whether the serving cell in the first CG is configured with multiple TPR PUSCH transmissions and whether the second CG is configured with two-PHR mode. For example, when the serving cell is configured with multiple TRP PUSCH transmissions, it may utilize the PHR solution proposed herein, i.e., determining PH value based on combined power transmissions on the multiple TRPs; when the serving cell is not configured with multiple TRP PUSCH transmissions, it means there is only one PUSCH transmission in the serving cell and thus only one PH associated with the single PUSCH transmission is reported. As such, the second CG may always receive on PH and does not need to know the details of how the power is used within the serving cells of the first CG or about the configuration of multiple TRPs.

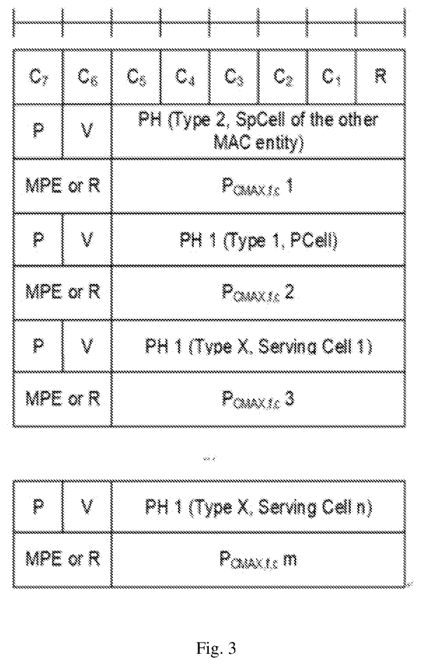

In some embodiments, information of the obtained PH corresponding to a serving cell configured with multiple TRPs may be carried by enhanced TRP MAC CE which contains PH information for the serving cell. The MAC CE may further comprise a plurality of fields corresponding different cells. Fields associated with the serving cells may be used to carry the PH information. Only for illustrative purposes, FIG. 3 shows an example PHR MAC CE format which can be used in example embodiments of the present disclosure.

As illustrated in FIG. 3, in the multiple entry PHR MAC CE format, a bitmap may be comprised in the PHR to indicate information of the PH. The bitmap includes Cᵢ field and this Cᵢ filed in the bitmap indicates the presence of a PH field for a serving cell with ServCellIndex i. If the Cᵢ field set to 1, it may indicate that a PH field for the serving cell with ServCellIndex i is reported or vice versa. If the Cᵢ field set to 0, it may indicate that a PH field for the serving cell with ServCellIndex i is not reported or vice versa.

In the PHR MAC CE format, the R field may be a reserved bit, set to “0”. The P field may indicate that whether the MAC entity has applied power backoff. The V field may indicate that whether the PH value is obtained based on the real transmission or virtual transmission based on a reference format. For Type 1 PH, V=0 may indicate that there is real transmission on PUSCH, and V=1 may indicate that using PUSCH reference format, or vice versa. For Type2 PH, V=0 may indicate that PUCCH real transmission, and V=1 may indicate that using PUCCH reference format, or vice versa. For Type3 PH, V=0 may indicate that SRS, and V=1 may indicate that using SRS reference format, or vice versa. That is, for the above three formats, V=0 may indicate the associated P_{CMAX,f,c} field, and V=1 may not contain P_{CMAX,f,c}. The PH field length may be 6 bits and indicate the PH level. The P_{CMAX,f,c:} field may be used to instruct P_{CMAX,f,c} to calculate the value of the PH field if P_{CMAX,f,c:} field is present.

As described, the PHR may comprise a V bit associated with a reported PH indicating whether the reported PH is real or virtual. In some embodiments, the method may comprise setting the V bit in the PHR based on status of the multiple PUSCH transmission in the serving cells and transmitting the PHR to the network device. The network device may be for example the second CG. Alternatively, the network device may be the first CG as well. In other words, as long as it is required to set V bit for PH in a serving cell with multiple TRPs configured, the solution for the V bit proposed herein may be utilized regardless whether the PHR is reported to the CG which the serving belongs to, or another CG.

In some embodiments, the terminal device may further be caused to set the V bit to a first value in case of no any of multiple PUSCH transmissions in the serving cell; or set the V bit to a second value different from the first value in case of at least one of multiple PUSCH transmissions in the serving cell.

In some embodiments, the first value and/or the second value may comprise 1 or 0. For example, The V bit which indicates virtual or real for the PH may be set to 1 (i.e., virtual PH) when there is no PUSCH transmission on any of the multiple TRPs, i.e., none of the multiple TRPs has any PUSCH transmission. It may be set to 0 (i.e., real PH) when there is PUSCH transmission on any of the multiple TRPs, i.e., as long as there is PUSCH transmission in the serving cell. In such a case, the receiving node would not need to know if there was transmission in one or both of the TRPs.

In some embodiments, the obtaining a PH corresponding to a serving cell may comprise obtaining the PH based on a sum of transmission powers of multiple PUSCH transmission in the serving cell and a maximum allowable transmission power of the serving cell.

In an example, when there is only one real PUSCH transmission in a serving cell, the terminal device may set the V bit to 1, which indicates that the PH is real, and in such a case, the PH may be obtained based on transmission power of the one real PUSCH transmission in the serving cell and the maximum allowable transmission power of the serving cell.

In another example, when there are more than one real PUSCH transmissions, for example two or more, the terminal device may set V bit to 1, and the PH may be obtained based on a sum of transmission powers of multiple PUSCH transmissions in the serving cell and the maximum allowable transmission power of the serving cell.

In yet another example, when there is no any real PUSCH transmission in a serving cell, the terminal device set the V bit to 0, which indicates that the PH is virtual, and in such a case, the PH may be obtained based on only one of multiple TRPs (for example, based on PUSCH reference format thereof) in the serving cell and a maximum allowable transmission power of the serving cell. For example, the terminal device could obtain the PH based on the first TRP in the multiple TRPs.

It is to noted that the above solution about the V bits is described in combination with the solution for PH as proposed herein; however, this solution about the V bit can constitute another independent aspect of the subject patent, to implement separately from the solution for PH as proposed herein.

In some embodiments, the proposed PHR may be defined as a new PH type, for example Type 4 PH, for serving cells configured with multiple TRP PUSCH transmission, which indicates the power headroom left after the combined power of the multiple TPR PUSCH transmissions when only one PH is reported to the MAC entity for a serving cell of the other MAC entity.

As mentioned above, PH associated with multiple SRS or PUCCH transmissions may also use the PHR solution proposed in the present disclosure. Due to the fact that the principle of PH determination are similar among PH associated with multiple PUSCH, SRS PUCCH transmissions, details about PH associated with multiple SRS or PUCCH transmissions will be omitted for simplification purposes and one may refer to the description of multiple PUSCH transmissions.

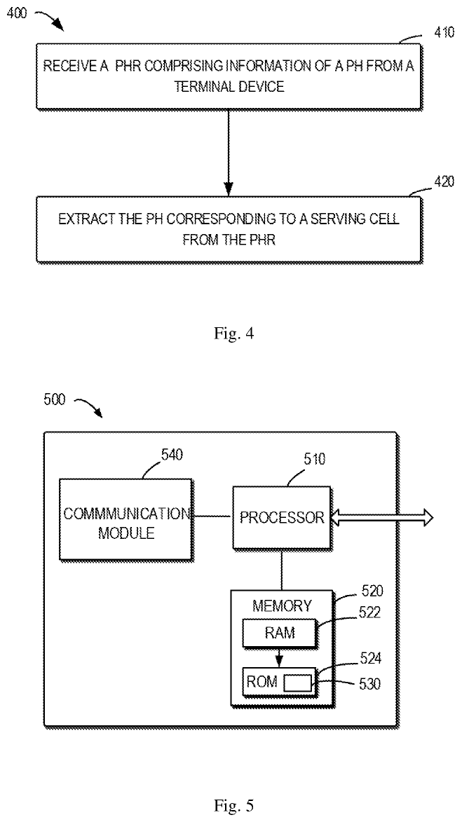

FIG. 4 illustrates a flowchart of a method 400 implemented at a network device in accordance with some embodiments of the present disclosure. For the purpose of discussion, the method 400 will be described from the perspective of the network device 120 or 130 with reference to FIG. 1. It is to be understood that method 400 may further include additional blocks not shown and/or omit some shown blocks, and the scope of the present disclosure is not limited in this regard.

At block 410, the network device 120 receives a power headroom report, PHR, comprising information of a power headroom, PH, from a terminal device. In other words, the network device 120 can obtain information of a PH based on the PHR. The PH may correspond to the serving cell in a first cell group, CG, and be determined based on the PH obtainment solution proposed herein. In other words, the PH indicates a PH obtained based on combined transmission power of multiple physical uplink shared channel, PUSCH, transmissions in the serving cell.

In some embodiments, the terminal device may be configured with dual connectivity with the first CG and a second CG; and/or wherein the serving cell is configured with multiple transmission and reception points, TRPs and the multiple PUSCH transmissions are on the multiple TPRs in the first CG for example.

In some embodiments, the second CG may be configured without a two-PHR mode. In other words, the PH obtainment solution is applied only when the CG which the PHR is reported does not support or is not configured with the two-PHR mode.

In some embodiments, the first CG may be configured with the two-PHR mode.

At block 420, the network device 120 or 130 may extract the PH corresponding to a serving cell from the PHR, wherein the PH corresponding to the serving cell in a first cell group, CG, and may indicate a PH obtained based on combined transmission power of multiple physical uplink shared channel, PUSCH, transmissions in the serving cell.

In some embodiments, the PH contained in the PHR may be obtained based on combined transmission power of multiple physical uplink shared channel, PUSCH, transmissions in the serving cell regardless whether the second CG is configured with the two-PHR mode. Thus, the PHR may always comprise only one PH for cross cell group reporting regardless of whether the serving cell in the first CG is configured with multiple TPR PUSCH transmissions and whether the second CG is configured with two-PHR mode.

In some embodiments, the PHR may comprise a V bit associated with a reported PH indicating whether the reported PH is virtual and the V bit may include a first value or a second value, and wherein the first value may indicate no any of multiple PUSCH transmissions in the serving cell, and the second value may indicate a least one of multiple PUSCH transmissions in the serving cell.

In some embodiments, the first value and/or the second value may comprise 1 or 0. For example, the first value is 1 to indicate the PH is a virtual and the second value is 0 to indicate that the PH is not virtual but computed based real powers.

In some embodiments, the PH may be obtained by based on a sum of transmission powers of multiple PUSCH transmissions in the serving cell and a maximum allowable transmission power of the serving cell.

FIG. 5 is a simplified block diagram of a device 500 that is suitable for implementing embodiments of the present disclosure. The device 500 may be provided to implement the communication device, for example the terminal device 110, the network device 120 or the network device 130 as shown in FIG. 1. As shown, the device 500 includes one or more processors 510, and one or more transmitters and/or receivers (TX/RX) 540 coupled to the processor 510. The device 500 may further include one or more memories 520 coupled to the processor 510.

The TX/RX 540 may be for bidirectional communications. The TX/RX 540 has at least one antenna to facilitate communication. The communication interface may represent any interface that is necessary for communication with other network elements.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 6 may perform any suitable actions and processing by loading the program 630 into the RAM 522.

The embodiments of the present disclosure may be implemented by means of the program 530 so that the device 500 may perform any process of the disclosure as discussed with reference to FIGS. 2 to 4. The embodiments of the present disclosure may also be implemented by hardware or by a combination of software and hardware.

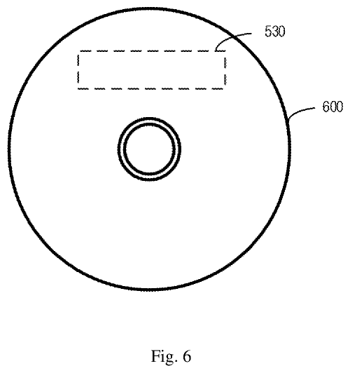

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 or 400 as described above with reference to FIGS. 2-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-23. (canceled)

24. A terminal device, comprising:
at least one processor; and
at least one memory including computer program code; wherein the at least one memory and the computer program code are configured to, with the at least one processor, cause the terminal device at least to:
obtain a power headroom corresponding to a serving cell in a first cell group, based on combined transmission power of multiple physical uplink shared channel, PUSCH, transmissions in the serving cell; and
transmit a power headroom report, PHR, comprising information of the obtained power headroom to a second cell group.

25. The terminal device of claim 24, wherein the terminal device is configured with dual connectivity with the first cell group and the second cell group; and/or
wherein the serving cell is configured with multiple transmission and reception points, TRPs, and the multiple PUSCH transmissions are on the multiple TPRs.

26. The terminal device of claim 24, wherein the obtaining a power headroom corresponding to a serving cell comprises:
obtaining the power headroom corresponding to the serving cell in the first cell group when the second cell group is configured without a two-PHR mode.

27. The terminal device of claim 24, wherein the first cell group is configured with the two-PHR mode.

28. The terminal device of claim 24, wherein the obtaining a power headroom corresponding to a serving cell comprises:
obtaining the power headroom corresponding to the serving cell in the first cell group and the PHR is transmitted to the second cell group, regardless whether the second cell group is configured with the two-PHR mode.

29. The terminal device of claim 24, wherein the PHR comprises a V bit associated with a reported power headroom indicating whether the reported power headroom is virtual, wherein the terminal device is further caused to:
set the V bit to a first value in case of none of PUSCH transmissions in the serving cell being performed; or
set the V bit to a second value different from the first value in case of at least one of PUSCH transmissions in the serving cell being performed.

30. The terminal device of claim 29, wherein the first value and/or the second value comprises 1 or 0.

31. The terminal device of claim 24, wherein the obtaining a power headroom corresponding to a serving cell comprises:
obtaining the power headroom based on a sum of transmission powers of PUSCH transmission in the serving cell and a maximum allowable transmission power of the serving cell.

32. A network device, comprising:
at least one processor; and
at least one memory including computer program codes, wherein the at least one memory and the computer program codes are configured to, with the at least one processor, cause the network device to:
receive a power headroom report, PHR, comprising information of a power headroom from a terminal device, and
extract the power headroom corresponding to a serving cell from the PHR,
wherein the power headroom corresponding to the serving cell in a first cell group and indicates a power headroom obtained based on combined transmission power of multiple physical uplink shared channel, PUSCH, transmissions in the serving cell.

33. The network device of claim 32, wherein the terminal device is configured with dual connectivity with the first cell group and a second cell group; and/or
wherein the serving cell is configured with multiple transmission and reception points, TRPs and the multiple PUSCH transmissions are on the multiple TPRs.

34. The network device of claim 32, wherein the second cell group is configured without a two-PHR mode.

35. The network device of claim 32, wherein the first cell group is configured with the two-PHR mode.

36. The network device of claim 32, wherein the power headroom is obtained based on combined transmission power of multiple physical uplink shared channel, PUSCH, transmissions in the serving cell regardless whether the second cell group is configured with the two-PHR mode.

37. The network device of claim 32, wherein the PHR comprises a V bit associated with a reported power headroom indicating whether the reported power headroom is virtual and the V bit has a first value or a second value, and
wherein the first value indicates none of PUSCH transmissions in the serving cell being performed, and the second value indicates a least one of PUSCH transmissions in the serving cell being performed.

38. The network device of claim 37, wherein the first value and/or the second value comprises 1 or 0.

39. The network device of claim 32, wherein the power headroom is obtained by based on a sum of transmission powers of PUSCH transmissions in the serving cell and a maximum allowable transmission power of the serving cell.

40. A method comprising:
obtaining a power headroom corresponding to a serving cell in a first cell group, based on combined transmission power of multiple physical uplink shared channel, PUSCH, transmissions in the serving cell; and
transmitting a power headroom report, PHR, comprising information of the obtained power headroom to a second cell group.

41. The method of claim 40, wherein the obtaining a power headroom corresponding to a serving cell comprises:
obtaining the power headroom corresponding to the serving cell in the first cell group when the second cell group is configured without a two-PHR mode.

42. The method of claim 40, wherein the obtaining a power headroom corresponding to a serving cell comprises:
obtaining the power headroom corresponding to the serving cell in the first cell group and the PHR is transmitted to the second cell group, regardless whether the second cell group is configured with the two-PHR mode.

43. The method of claim 40, wherein the PHR comprises a V bit associated with a reported power headroom indicating whether the reported power headroom is virtual, wherein the method further comprising:
setting the V bit to a first value in case of none of PUSCH transmissions in the serving cell being performed; or
setting the V bit to a second value different from the first value in case of at least one of PUSCH transmissions in the serving cell being performed.
